(19) United States
(12) Patent Application Publication
(10) Pub. No.: US 2025/0153823 A1
(43) Pub. Date: May 15, 2025

(54) OUTBOARD PROPULSION UNIT

(71) Applicant: RAD PROPULSION LTD, Chichester (GB)

(72) Inventor: John Daltry, Chichester (GB)

(21) Appl. No.: 18/695,188

(22) PCT Filed: Jul. 19, 2022
(86) PCT No.: PCT/GB2022/051857

§ 371 Date: Mar. 25, 2024

(30) Foreign Application Priority Data
Oct. 6, 2021 (GB) 2114288.0

(51) Int. Cl. B63H 20/08; B63H 20/14

(52) U.S. Cl. CPC B63H 20/08; B63H 20/14

(57) ABSTRACT

An outboard boat motor (10) mountable on a transom of a watercraft comprises a tiller (12), a shaft (20) with a propulsion arrangement (22), and a transom mount (30) for attachment to a transom. In one aspect, the tiller (12) is articulatable. e.g. pivotable, into a position extending, axially aligned, from the shaft (20), to serve as a lever for pivoting the shaft (20) into a use position. In another aspect, the transom mount (30) comprises a transom-mounting subassembly (40) and a motor-receiving subassembly (32), wherein the transom mount (30) is detachable. e.g. slidably detachable, on the shaft (20). The aspects individually and combined facilitate the installation of the motor (10) onto a transom, and allow also for a more compact configuration for transport and storage.

### FIELD OF THE INVENTION

The present invention relates to marine outboard motors. More specifically, the present invention relates to an external outboard motor mountable to a transom of a boat, such as a small boat, dinghy etc, either as main motor or as auxiliary drive.

### BACKGROUND

Outboard motors are a common type of marine propulsion system that comprise the motor engine, thrust-generator and tiller (steering arm) in a self-contained unit that is mountable to a watercraft transom and removable for transport, storage and maintenance.

Depending on the size and type of watercraft, an outboard motor may be used as a main propulsion unit, and/or as an auxiliary propulsion unit. It is not uncommon that outboard motors are mounted to a transom only shortly before launch, while a boat is on land, or require mounting, adjustment or removing at sea.

GB2057379A discloses a tiller for an outboard motor for use with a boat hull, comprising in combination a tiller arm pivoted about a tiller head able to be fixed to a tiltable motor board on said hull, the tiller arm and tiller head having one unlocked and two locked positions.

US2009075534A1 discloses a tiller arm pivotably mountable to a marine outboard engine, comprising a handle portion and throttle grip rotatably mounted to the handle portion and rotatable with respect thereto about a throttle grip axis generally perpendicular to the pivot axis.

U.S. Pat. No. 4,066,032A relates to an outboard motor having a water submergible electric drive member, a shaft member fixedly attached to the drive member, an attachment member for movably attaching the shaft member to a boat, and an electric circuit for allowing electrical power to selectively pass from an electric storage battery to the drive member. The electric circuit is adapted to allow the drive member to be raised or lowered relative to the attachment member without breaking the electrical contact between the electric storage battery and the drive member.

JP2007210549A discloses an outboard motor comprising a moveable cavitation plate.

US2010032545A1 describes an apparatus for mounting a trolling motor to a watercraft, using a bracket, a coupling hinge, a lift arm, a cam mechanism, a collet, a resistance knob, and two bias springs. The apparatus is provided to tilt the trolling motor between a stowed position and a deployed position.

GB1129478A discloses an outboard motor that may be housed in an inoperative position in a stern compartment of a water craft, and may be moved the vertical operative position via a trolley.

The weight distribution of a motor and typically unstable conditions at sea make mounting and removing an outboard motor, with most of its weight outboard, a relatively awkward procedure. Larger watercraft tend to require correspondingly large motors that are more difficult to handle due to their weight. Smaller watercraft are used with relatively lighter outboard motors, but are inherently less stable at sea, which requires mounting and lifting a motor while keeping balance. As a consequence, dropped-motor incidents are not uncommon.

The present invention seeks to provide an outboard motor design that alleviates some of the shortcomings of known products.

### SUMMARY OF THE INVENTION

In accordance with a first aspect of the present invention, there is provided an outboard propulsion unit as defined in claim 1. The outboard propulsion unit is of the type mountable on a transom of a watercraft, and comprises a tiller, an outboard shaft comprising a propulsion arrangement, and a transom mount for attachment to a transom, wherein the tiller is articulatable into an extended configuration axially aligned with the outboard shaft and extending from a tiller-connecting end of the outboard shaft.

The tiller may be articulatable into one of many positions, for instance a steering configuration, an extended configuration, and a stowed configuration. In the steering configuration, the tiller is protruding laterally, at a generally perpendicular angle, relative to the outboard shaft. In the extended configuration, the tiller extends the length of the outboard shaft and is oriented generally in the extension of the axis of the outboard shaft. In the stowed configuration, the tiller is aligned with the outboard shaft and alongside the outboard shaft, to avoid extending the overall length of the motor.

In some embodiments, the outboard propulsion unit comprises a tiller-locking arrangement allowing the tiller to be locked in the extended configuration.

This allows the tiller to be locked in a configuration in which it is axially aligned with the outboard shaft, to provide a lever that can be used to pivot, or to manually control pivoting of, the outboard motor into and out of a deployed position. By locking the tiller in position, it can be avoided that the tiller collapses relative to the outboard shaft while it is used as a lever.

In some embodiments, the tiller is articulatable into a steering configuration from the extended configuration.

In some embodiments, the tiller is articulatable into a stowed configuration along the outboard shaft.

In some embodiments, the tiller is articulatable into the stowed configuration from the extended configuration.

In some embodiments, the outboard shaft and the tiller comprise tiller-shaft-engaging structures configured to latch the tiller in the stowed configuration along the outboard shaft.

By way of the tiller-shaft engaging structures, the tiller can be held securely on the outboard shaft. This allows the tiller to be used as a handle for carrying the motor, the outboard shaft being retained in position relative to it.

In some embodiments, the tiller comprises a carrier handle arrangement located, when in a stowed configuration, opposite the outboard shaft.

In some embodiments, at least a portion of the carrier handle arrangement is located near a shaft-connected end of the tiller.

In some embodiments, at least a portion of the carrier handle arrangement is located near the outboard shaft's propulsion end when the tiller is in the stowed configuration.

In some embodiments, the tiller is articulatable by way of a pivotable connection.

In some embodiments, the transom mount comprises a transom-mounting subassembly and a motor-receiving subassembly, the transom-mounting subassembly for attachment to a transom, the motor-receiving subassembly being connectable to the outboard shaft in a translatable engagement, the translatable engagement allowing positioning the motor-receiving subassembly at one of a plurality of shaft locations, wherein at one of the shaft locations the motor-receiving subassembly is detachable from the outboard shaft, and at another one of the shaft locations the motor-receiving subassembly is retained on the outboard shaft.

In accordance with a second aspect of the present invention, there is provided an outboard propulsion unit as defined in claim 12. The outboard propulsion unit is of the type mountable on a transom of a watercraft, and comprises a tiller, an outboard shaft comprising a propulsion arrangement, and a transom mount for attachment to a transom, wherein the transom mount comprises a transom-mounting subassembly for attachment to a transom and a motor-receiving subassembly, the motor-receiving subassembly being connectable to the outboard shaft in a translatable engagement, the translatable engagement allowing positioning the motor-receiving subassembly at one of a plurality of shaft locations, and wherein at one of the shaft locations the motor-receiving subassembly is detachable from the outboard shaft, and at another one of the shaft locations the motor-receiving subassembly is retained on the outboard shaft.

The transom mount of the first aspect or second aspect may, as such, be of two-component form, the two components being provided by the transom-mounting subassembly and the motor-receiving subassembly. The motor-receiving subassembly may be pivotably connected on the transom-mounting subassembly and may be detachable from the outboard shaft.

In some embodiments, the translatable engagement is a slidable engagement.

This allows the motor-receiving subassembly to be moved in a sliding engagement along at least a portion of the outboard shaft.

In some embodiments, the outboard shaft comprises a track structure along which the motor-receiving subassembly is slidable, wherein the track structure comprises a rail section limiting rotation of the motor-receiving subassembly relative to the outboard shaft.

The track structure may comprise lateral rails or edge structures between which a protrusion of the motor-receiving subassembly may be slotted to engage slidably in the track structure. The lateral rails or edge structures may have different spacing between them, including sections with narrower spacing and sections with wider spacing. The protrusion of the motor-receiving sub-assembly may comprise a wider end portion on a narrower shaft. It can be imagined that the protrusion of the motor-receiving subassembly may be inserted into or removed from the track structure at a section with wider spacing between the edge structures, yet may be retained in sections with narrower spacing between the edge structures, by way of the wider end portion preventing removal at a section with narrower spacing. Thereby, an arrangement is provided in which the motor-receiving subassembly is slidable between locations of the outboard shaft at which it is either retained (by a narrow track spacing) or detachable (at sections with wider track spacing).

In some embodiments, the track structure comprises a free section configured to permit rotation of the motor-receiving subassembly relative to the outboard shaft more than the rail section, the free section being at an end of the track structure.

In some embodiments, the outboard shaft comprises a shuttle mechanism providing the translatable engagement, the shuttle mechanism configured to engage with a corresponding structure of the motor-receiving subassembly, the shuttle mechanism being translatable along a length of the outboard shaft.

The shuttle mechanism is understood to comprise a connector component integrally and slidably disposed on the outboard shaft, onto which the motor-receiving subassembly may be attached.

In some embodiments, the motor-receiving subassembly is pivotably connected on the transom-mounting subassembly.

The pivotable connection may be provided in a manner allowing the motor shaft to be pivoted between a vertical (in use) orientation approximately parallel to a transom wall at a position of at least 70 degrees, at least 75 degrees, at least 80 degrees, at least 85 degrees, or at least 90 degrees relative to the transom wall.

In some embodiments, the transom mount comprises a pivot-controlling interlock, the interlock mechanically preventing a pivoting of the motor-receiving subassembly and being releasable to permit pivoting.

In some embodiments, the interlock is releasable by a release actuator located on the transom mount, and/or by a release actuator located near a tiller-connecting end of the outboard shaft.

In some embodiments, the outboard shaft comprises a rod structure engageable in a through hole of the motor-receiving subassembly.

The motor-receiving subassembly and/or a protrusion thereof may comprise a hole for engagement with a corresponding rod of the outboard shaft. The rod may be located within the above-mentioned track structure. It will be understood that the rod may help to retain the motor-receiving subassembly on the outboard shaft. The rod may be provided to define a position at which the outboard shaft is retained, instead of or in addition to a track with different slot widths.

In some embodiments, the rod structure is exposed within a recess at a side of the outboard shaft so as to allow the motor-receiving subassembly to be slid onto it.

Any one or more of the embodiments described in relation to the first aspect may be combined with any one or more embodiments described in relation to the second aspect.

### DESCRIPTION OF THE FIGURES

Exemplary embodiments of the invention will now be described with reference to the Figures, in which:

FIG. 1 is an isometric illustration of a motor embodiment in a deployed configuration;

FIG. 2 is a side view of a motor detached from a transom mount;

FIG. 3 is an underneath isometric view of a motor in an first mounted configuration;

FIG. 4 is a side view of a motor in the FIG. 3 configuration;

FIG. 5 is a side section view of a motor in the FIG. 3 configuration;

FIG. 6 is a side view of a motor in a second mounted configuration;

FIG. 7 is a side section view of a motor in the FIG. 6 configuration;

FIG. 8 is an isometric view of part of a locking mechanism in a first configuration;

FIG. 9 is an isometric view of part of a locking mechanism in a second configuration;

FIG. 10 is a side view of a motor in an extended configuration, pivoted inboard;

FIG. 11 is a side view of a motor in an extended configuration, pivoted outboard;

FIG. 12 is a side view of a motor in a deployed steering configuration;

FIGS. 13 to 22 are images of different steps of an installation sequence of a prototype embodiment;

FIG. 23 shows a prototype embodiment in a collapsed condition for transport; and

FIG. 24 shows a prototype embodiment in another collapsed condition for transport.

### DESCRIPTION

FIG. 1 shows an outboard motor 10, or boat motor, comprising a tiller 12 with a tiller handle 14, an outboard shaft 20 constituting a leg comprising at an end thereof (in use, the water-submerged end) a propulsion arrangement 22, and on a side of the outboard shaft 20 a transom bracket 30 comprising a connector-receiving portion 32, constituting a motor-receiving subassembly, and a transom-clamping portion 40, constituting a transom-mounting subassembly.

The tiller 12 is connected at a tiller-connecting end 21 of the outboard shaft 20 via a pivot link 18 constituting an articulatable connection. In use, the tiller-connecting end 21 is the upper end of the outboard shaft 20, opposite the water-submerged end. The pivot link 18 carries a handle lever 24. In FIG. 1, the outboard motor 10 is in a deployed steering configuration in which the tiller 12 is positioned laterally (generally perpendicularly) to the axis of the outboard shaft 20. The tiller 12 comprises, on a surface of its body that is in the steering position facing down, one or more carrier structures 16. As illustrated in FIG. 1, the handle lever 24 is sandwiched between the tiller 12 and the outboard shaft 20, however the tiller 12 may be lifted (pivoted upwards) somewhat in line with the preference of a user during steering, providing clearance for the handle lever 24 to be lifted.

When in use, the transom bracket 30 will be clamped to a transom (transom not shown in FIG. 1) of a watercraft, such that the outboard shaft 20 extends at least partially below a water level, such that the propulsion arrangement 22 is submerged. The outboard shaft 20 is pivotable sideways relative to the transom bracket 30, by way of using the tiller 12 as a steering lever, to steer the propulsion arrangement 22 and thereby the watercraft.

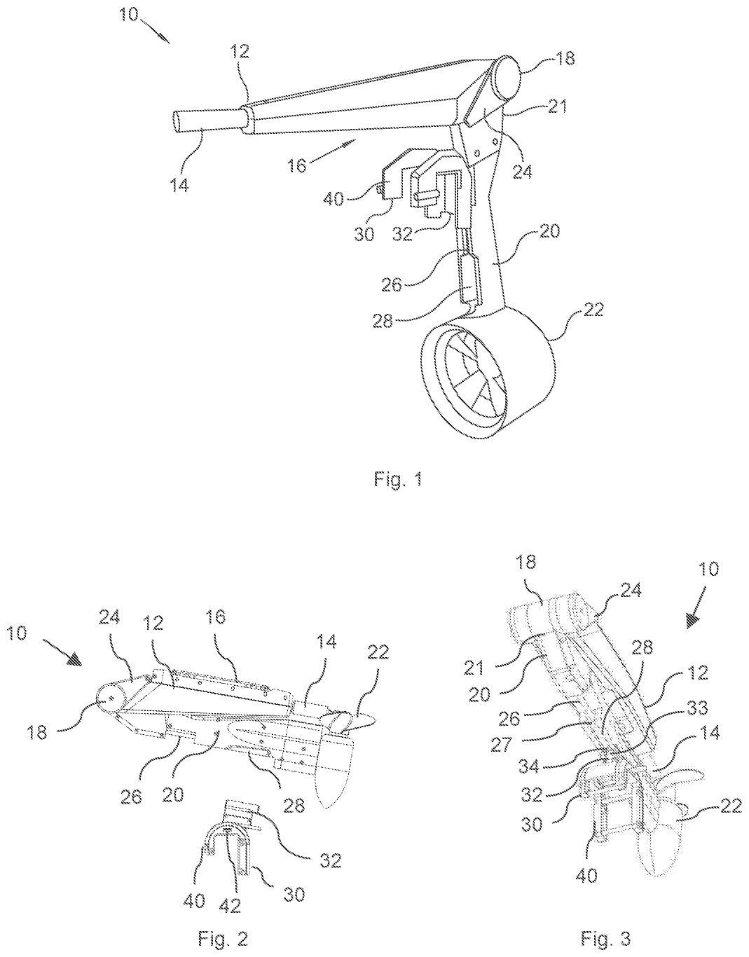

Referring to FIGS. 2 to 12, the same numerals are used as in FIG. 1 for equivalent components of the outboard motor 10, without repeating the detailed description thereof. Near the propulsion arrangement 22, the outboard shaft 20 comprises a recess 28 providing a void into which the connector-receiving portion 32 of the mounting bracket 30 may be inserted. The recess 28 extends along a length, practically the full length, of the outboard shaft 20. The side wall edges of the recess 28 define between them an elongate spacing that provides a guide track allowing the connector-receiving portion 32 to be slid along the outboard shaft 20 while being engaged in the recess 28. The connector-receiving portion 32 comprises an engagement protrusion 33 that can be inserted into the recess 28, and it will be understood that the degree of rotation of the connector-receiving portion 32 relative to the recess 28 is limited by the side walls of the recess 28. At its end, the engagement protrusion 33 comprises a through hole 34 axially extending along the direction of the recess 32 when located in the recess 32.

The outboard shaft 20 comprises a connector bar 26 constituting a connector and extending along a portion of the outboard shaft 20. The connector bar 26 extends from an end of the recess 28 at the tiller-connecting end 21 towards the water-submerged end of the outboard shaft 20, and comprises a free connector end 27, provided by the end of the connector bar 26, that extends partway along the recess 28, no further than necessary to permit the connector-receiving portion 32 to be received in the recess 28 at one end thereof without interference with connector bar 26.

The free connector end 27 comprises a conically tapering end portion to facilitate insertion into the through hole 34 (described below with reference to FIGS. 5 and 7). The through hole 34 is dimensioned with a sufficient diameter to receive the connector bar 26 when axially aligned with it. This allows the connector-receiving portion 32 to be moved along the recess 28 and brought into engagement with the connector bar 26, on which the connector-receiving portion 32 is thereby slidably retained.

FIG. 2 shows the outboard motor 10 in side view, detached from the mounting bracket 30. The connector-receiving portion 32 of the transom bracket 30 is pivoted upward relative to the transom-clamping portion 40, at a motor-mounting angle, at which the connector-receiving portion 32 faces upward to be able to be engaged in the recess 28 of the outboard shaft 20. The connector-receiving portion is pivotable on the transom-clamping portion 40, and latchable at the motor-mounting angle, facing upward. The connector-receiving portion 32 can be unlatched by a release actuator 42 that is provided in the form of a lever. However, other release mechanisms may be used, such as release axles or pull mechanisms. By providing a latchable connection between the connector-receiving portion 32 and the transom-clamping portion 40, pivoting is prevented while the outboard shaft 20 is pushed outward along the connector-receiving portion 32. This allows a user to confidently push the outboard shaft along the connector-receiving portion 32 without having to consider a risk of the motor pivoting into an outboard position before it is securely attached. In the described embodiment the motor mounting angle at which the outboard shaft 20 is held is about 80 degrees relative to the transom plane, i.e. close to a horizontal orientation while providing an incline to assist pushing the outboard shaft 20 outward, into an engaged position. The motor mounting angle may be at least 70, 75, 80, or 85 degrees. The motor mounting angle may be no more than 90, 89, 88, 87, 86, 85, 84, 83, 82, 81 or 80 degrees. Thereby, the outboard shaft 20 can be held practically horizontally, or at between 90 and 70 degrees relative to a vertical transom plane, when it is lowered to engage the transom bracket 30.

FIG. 3 shows the outboard motor 10 from underneath the connector-receiving portion 32 inserted in the recess 28.

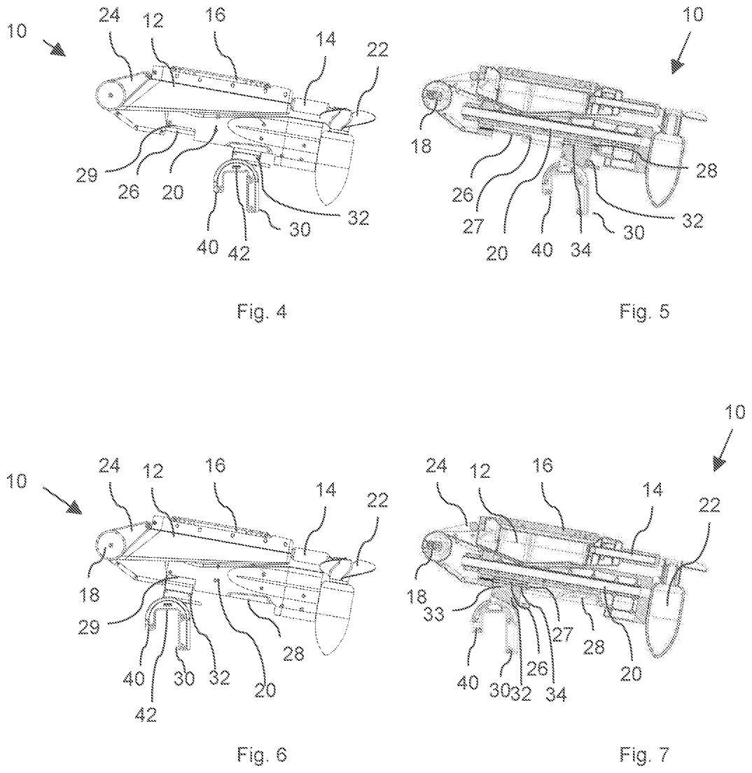

FIGS. 4 and 5 show the outboard motor 10 in side view and section, respectively, in a stowed configuration and inboard-pivoted horizontal position. To this end, the tiller 12 of the outboard motor 10 is stowed along the outboard shaft 20. Conveniently, the tiller 12 is positioned at a different side (here: opposite) of the outboard shaft 20 than the transom-connecting element such as the recess 28. In the stowed configuration, the tiller handle 14 is close to the propulsion arrangement 22, although it will be understood that the relative position of the tiller handle 14 depends on the relative lengths of the outboard shaft 20 and the tiller 12. The through hole 34 of the connector-receiving portion 32 is axially aligned with the connector bar 26 yet the connector bar 26 and connector-receiving portion 32 are located at opposite ends of the outboard shaft 20, and not yet brought into engagement. If desired, the outboard shaft 20 could be lifted upward. Much of the mass of the outboard shaft 20 is inboard of the transom. As such, in the event of an accidental drop, the outboard shaft 20 is more likely to fall on board.

FIGS. 6 and 7 show the outboard motor 10 in side view and section, respectively, in an outboard (outwardly extended), horizontal position. The outboard shaft 20 has been moved into the outboard position via a sliding engagement between the connector portion 26 engaged in the recess 28, whereby portions of the recess 28 provide a track structure allowing the connector-receiving portion 32 to be pushed towards and onto the connector bar 26. Thereby, the free connector end 27 is inserted and pushed through the through hole 34. The connector bar 26 has a length sufficient to protrude through the length of the through hole 34. Thereby, the connector-receiving portion is securely retained in the recess 28 by the connector bar 26, removable only by first sliding the outboard shaft 20 to the inboard position to disengage the connector bar 26. It will be understood that the connector bar 26 is securely anchored within the recess of the outboard shaft and/or may be integrally manufactured. The arrangement allows the outboard motor 10 to be attached to the mounting bracket 30, in a horizontal or near-horizontal orientation, before it is lowered into water. In the outboard/outwardly extended configuration of FIGS. 6 and 7, much of the mass is outboard. However, a dropped-motor incident is practically impossible following the secure engagement of the connector bar 26 in the through hole 34.

Near the tiller-connecting end 21, the side walls of the recess 28 are relatively further apart than at other sections of the recess 28, providing a free end section 29. The free end section 29 is preferably at least as long, in the axial direction of the outboard shaft 20, as the engagement protrusion 33 (see FIG. 3). The absence of narrower side walls at the free end section 29 allows the connector-receiving portion 32 to be rotated about the axis provided by the connector bar 26, while being securely retained against removal from the recess 28. In this position, the outboard shaft 20 can be pivoted laterally for steering. However, it will be understood that outboard motors with other steering mechanisms, not using the tiller 12 as steering lever, may not require a free end section.

The tiller 12 is pivotable about the pivot link 18 axis, upwards and backwards, by about 270 degrees, to be moved from the stowed configuration to the steering configuration, and vice versa. In addition, the tiller 12 is lockable in a lever configuration in which it is oriented in an extension of the axis of the outboard shaft 20 to provide an extension of the outboard shaft 20. The lever configuration may be about 180 degrees relative to the axis of the outboard shaft 20, although in embodiments the tiller 12 may be lockable at a pre-determined axial alignment angle between 160 and 200 degrees or between 170 to 190 degrees.

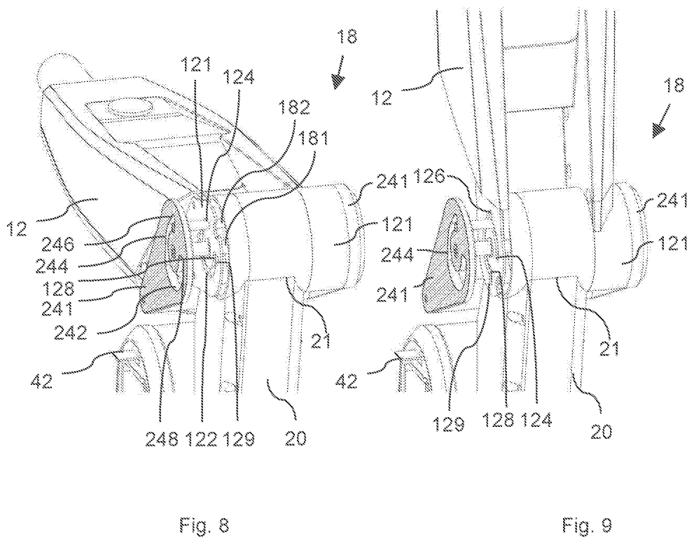

FIGS. 8 and 9 show a detail view of the pivot link 18. The tiller 12 is hingedly attached via a tiller mount 121 to the pivot-connecting end 21 of the outboard shaft 20. The tiller connection comprises a mounting axle 181 about which the tiller 12 is rotatable relative to the outboard shaft 20. The outboard motor 10 further comprises a tiller-latching mechanism. And exemplary embodiment of a tiller-latching mechanism is described in FIGS. 8 and 9. The tiller-latching mechanism comprises a biased bar 182 extending parallel to the mounting axle 181 and slidably retained within the pivot-connecting end 21 so as to allow the spacing between the biased bar 182 and the mounting axle 181 to be altered towards the mounting axle 181 (proximally) or away from it (distally). The biased bar 182 is biased distally by a biasing arrangement such as helical springs (not shown) although other biasing arrangements may be used. The spacing between the mounting axle 181 and the biased bar 182 can be altered by moving the biased bar 182 proximally, against the force of the biasing arrangement.

The tiller-latching mechanism includes, further, two guide formations 122 and 242. A first guide formation 122 is located on the end of the tiller mount 121 that is rotatably mounted on the mounting axle 181. A second guide formation 242 is located on an inside face 241 of the handle lever 24 which is rotatably mounted on the mounting axle 181. The guide formations are provided by arcuate slots in the tiller mount 121 and on the lever inside face 241. The length of the biased bar 182 is sufficient to protrude through the first guide formation 122, of the tiller arm 12, and into the second guide formation 242, of the handle lever 24. The first and second guide formations 122, 242 may be provided on both sides of the mounting axle 181 of the outboard shaft 20, however the description is provided for one side.

The guide formations 122 and 242 provide an arcuate guide track with ends 124, 128 and 246, 248, respectively, the ends 124, 128, 246, 248 limiting the pivoting range about the mounting axle 181 by way of an abutment of the biased bar 182 against one of the ends 124, 128 and 246, 248. Furthermore, the guide track 122 of the guide formation 121 of the tiller 12 comprises one or more dead-end branches 126, 129, branching into the distally-biased direction of the biased bar 182, such that the biased bar 182 is urged into the dead-end branches by way of the biasing arrangement, in the manner of a ratchet. When the biased bar 182 is urged into the dead-end branches 126, 129 of the guide track 122, this limits the range of rotation about the mounting axle 181 more than the ends 124, 128 of the guide formation 122.

The second guide formation 242 of the handle lever 24 comprises tapered wall portions providing a narrower length of track 244. When the guide formation 242 is rotated about the mounting axle 181, the biased bar 182 accordingly passes along the narrower track 244, where it is urged proximally by sidewalls of the track 244, and thereby out of engagement with the dead-end branches of the first guide formation, in the manner of a ratchet release. It will be appreciated that by rotating the handle lever 24 so as to urge and retain the biased bar 182 in a proximally retained position, the range of tiller rotation is less restricted, because the biased bar 182 is prevented from entering a dead-end branch. Conversely, by moving the handle lever 24 into a position in which the second guide formation 242 does not restrict the biased bar 182, the biased bar 182 may come into engagement with the dead end branches of the first guide formation 122, limiting the tiller rotation as set out above.

The described arrangement provides a tiller-release mechanism and a tiller-locking mechanism by allowing the range of tiller rotation about the mounting axle 181 to be limited by moving the handle lever 24 into one of a tiller-latching position and a tiller-releasing position.

The first guide formation 122 may comprise a dead end branching off perpendicularly to the arcuate guide track, to lock the tiller 12 against rotation in both directions. Alternatively or in addition, dead end branches may comprise a tapering side and a retaining side, locking the tiller 12 against rotation further than provided by the retaining side but allowing the tiller 12 to be released in the opposite direction, in the manner of a ratchet, whereby the tapering side provides a gradual retraction (in the proximal direction) of the biasing bar 182.

It will be appreciated that other tiller-locking and tiller-releasing mechanisms may be used, such as lateral latch pins that may or may not be biased into engagement with a corresponding catch, so as to be biased into a tiller-locking configuration and/or biased into a tiller-release configuration. It is preferred that the tiller 12 is lockable, or releasably latchable, in at least the lever configuration, in at least one direction, so as to allow the tiller 12 to be used as a lever extension of the outboard shaft 20. Conveniently, the tiller 12 is also lockable, or releasably latchable, in the stowed configuration, so as to ensure it is securely retained along on the outboard shaft 20 when desired. Further, it is desirable for the tiller 12 to have freedom to be pivotable upward and downward in the steering configuration, and as such to not be restricted, so as to allow the tiller 12 to be used at one of several angles in accordance with a user's preference or situation requirements.

The described mechanism, using a handle lever 24 with a biased bar 182 releasably engageable in rotation-limiting formations, provides a single mechanism for latching the tiller 12 at different tiller configurations. However, it will be appreciated that different mechanisms may be used as an alternative, or in addition. For instance, a separate latch may be provided at a location along the outboard shaft 20 to releasably lock the tiller 12 in a stowed configuration.

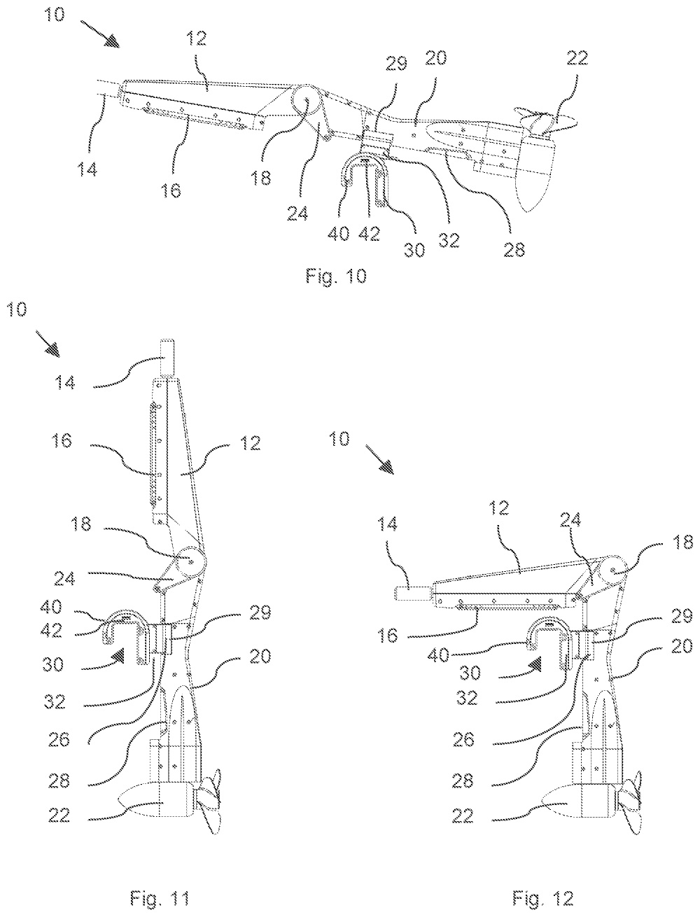

Turning to FIG. 10, the tiller 12 has been pivoted by about 180 degrees from the stowed configuration into an extended configuration in which it is axially aligned with the outboard shaft 20 to provide a lever configuration, by extending beyond the length of the outboard shaft 20. It will be appreciated from the illustration of FIG. 10 that relative to a fulcrum defined at the transom bracket 30, the tiller 12 extends further than the outboard shaft 20. Although the tiller 12 is illustrated as extending about 180 degrees in the extension of an axis of the outboard shaft 20, the angle between tiller 12 and outboard shaft 20 of the lever configuration may in some embodiments be other than 180 degrees, for instance at an angle between 160 and 200 degrees, or between 170 and 190 degrees. The purpose of the tiller's extended configuration is to provide a lever structure that can be used to control, for instance to slow down, the pivoting motion of the outboard shaft 20 as it is lowered into the water, wherein the connector-receiving portion 32 provides, for practical purposes, a fulcrum. The tiller 12 is locked by way of the tiller-latching mechanism illustrated in FIGS. 8 and 9, and so cannot be folded further towards a steering configuration from the extended configuration without first releasing the tiller-latching engagement of the biased bar. This allows a user to pull or push down on the tiller 12 as it swivels up due to the weight of the outboard shaft 20 pivoting into the water. In some embodiments, the tiller-latching mechanism may be configured to lock the tiller 12 in the extended configuration against folding in both the steering configuration and the stowed configuration. Such a configuration would allow a user to push the tiller 12 upward, without thereby moving it towards the stowed configuration. Locking the tiller 12 in both directions (against movement in both directions) allows the tiller 12 to be used as a lever to push the motor 10 with the outboard shaft 20 into the deployed configuration.

Turning to FIG. 11, the tiller 12 is in an extended configuration relative to the outboard shaft 20. By releasing the release actuator 42, the connector-receiving portion 32 is no longer prevented from pivoting about the transom-clamping portion 40. In this configuration the outboard shaft 20 is no longer restricted from pivoting into the water, and the tiller 12 can be used to better control the motor deployment by using the tiller 12 to control the swivel motion. In its deployed configuration, the connector-receiving portion 32 is latched relative to the transom-clamping portion 40 and may be released using the release actuator 42. In some embodiments, the connector-receiving portion 32 may be lockable at one of several different angles, to allow trimming of the motor angle in the deployed configuration.

In FIG. 12, the tiller 12 is pivoted about the pivot link 18, after having been released using the above-described tiller-latching mechanism, into a steering configuration that is a position generally perpendicular to the axis of the outboard shaft 20. It will be appreciated that the tiller 12 may be lifted upward a few degrees so as to allow it to be steered by people of different height, and/or to allow it to be steered while standing or sitting, and to allow the tiller 12 to be used at the same steering configuration regardless of the amount of trimming of the outboard shaft 20.

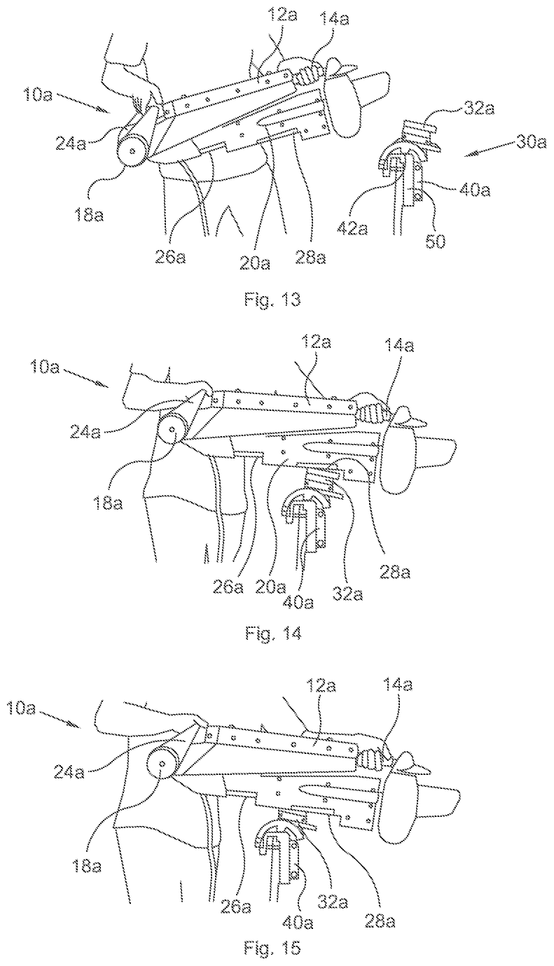

FIGS. 13 to 22 show photographs of a prototype 10a being installed on a board 50 of a motor trolley representing a transom. In FIGS. 13 to 22, like numerals are used for like elements disclosed in the preceding Figures, adding a suffix-a to distinguish between technical drawings and prototype embodiment.

FIG. 13 shows the transom bracket 30a pre-installed on the board 50. In practice, the transom bracket 30a may be installed at the time of mounting the motor 10a to a watercraft, or it may be permanently installed onto a watercraft transom. The connector-receiving portion 32a is pivoted upward relative to the transom-clamping portion 40a to its motor-mounting angle (here: about 80 degrees relative to the transom plane). The outboard motor 10a is handled via its tiller handle 14a and the handle lever 24a, which allows a user to hold the shaft recess 28a, facing downward, above the connector-receiving portion 32a for attachment. A particular advantage of the outboard motor 10a in the stowed configuration is that it may be handled with two arms and firmly grabbed at opposite ends, i.e. near the in-use lower end of the outboard shaft 20 and near the in-use upper end of the outboard shaft 20, thereby providing a good weight distribution.

In FIG. 14, the shaft recess 28a has been slotted over the connector-receiving portion 32a. Internal wall portions of the shaft recess 28a may be configured to provide guide structures urging the connector-receiving portion 32a into a position inside the outboard shaft 20a in which its through hole is axially aligned with the connector bar (not visible in FIG. 14, refer to FIGS. 5 and 7). By way of the guide structures, a user may simply let go of the tiller handle 14a to allow the outboard motor 10a to engage the connector-receiving portion 32a. Initially, the motor 10a is not secured on the connector-receiving portion, i.e. while the end of the connector bar 26a is not yet engaged in the through hole (not shown in FIG. 14, cf. through hole 34 in FIG. 5) of the connector-receiving portion 32a, the motor 10a may be lifted up from the connector-receiving portion 32a. However, a user may let the weight of the motor 10a rest relatively securely on the transom bracket 30a without having to hold most of the motor 10a overboard, as is the case with conventional outboard motors.

In FIG. 15, the outboard motor 10a is pushed outward (in an overboard direction), using the handle lever 24a and optionally also the tiller handle 14a, whereby the connector bar 26a engages in the through hole (see through hole 34 in FIG. 5) of the connector-receiving portion 32a, providing a track along which the connector-receiving portion 32a may slide. With the connector bar 26a engaged, the motor 10a can no longer be lifted upward and is retained on the transom bracket 30a. Portions of the shaft housing may be shaped to provide a rail structure that limits rotation of the connector-receiving portion 32a about the axis of the connector bar 26a. Alternatively, the connector bar 26a may comprise a rotation-preventing cross-section, e.g. a polygonal or anisotropic cross-section provided by a rut or ridge, along a portion of the length of the connector bar 26a.

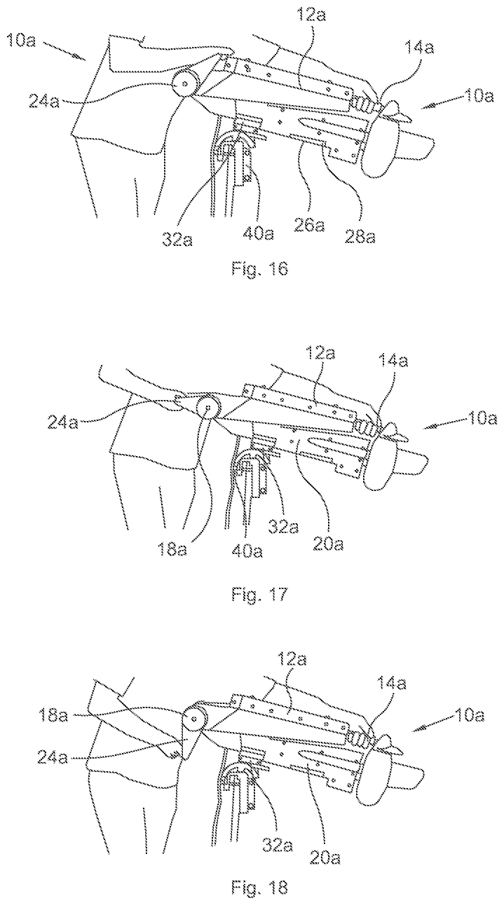

FIG. 16 shows the outboard motor 10a in a fully-outward position, the connector-receiving portion 32a being at a position closest to the pivot link 18a. At the pivot link 18a, the shaft recess 28a is wider and thereby no longer restricting a lateral pivoting of the connector-receiving portion 32a relative to the connector bar 26a, and thereby allows for a lateral pivoting of the motor shaft 20a relative the mounting bracket 40a.

In FIGS. 17 and 18, the tiller 12a is released from its stowed configuration by actuating the handle bar 24a (see tiller-latching mechanism described above). Comparison of FIGS. 16 and 17 reveals that the motor 10a is slightly tilted laterally, by way of the free end section 29 permitting lateral rotation of the outboard shaft 20a relative to the connector-receiving portion 32a.

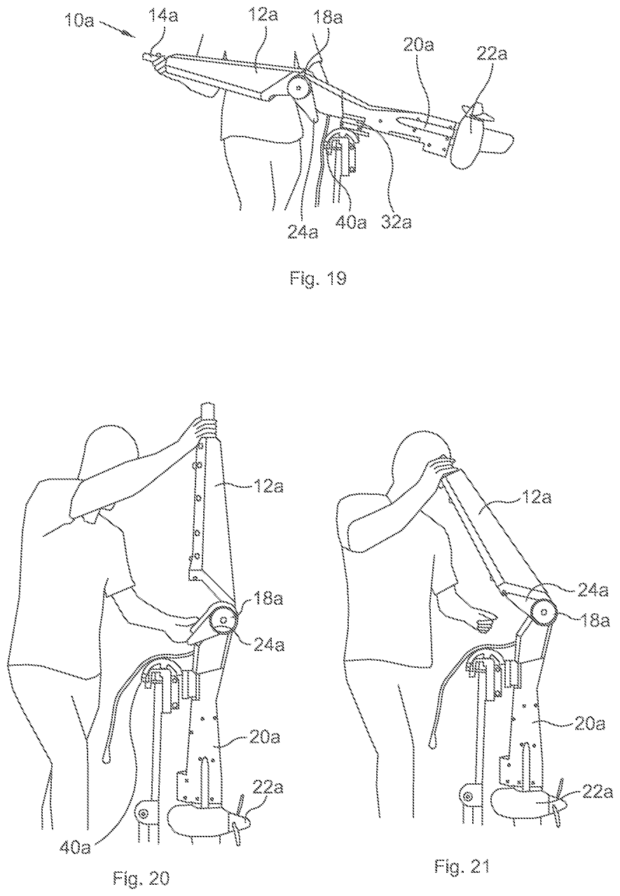

In FIGS. 19 and 20, the tiller 12a is articulated into an extended configuration in which it is axially aligned in the extension of the outboard shaft 20a, at about 180 degrees from the outboard shaft axis. In the extended configuration, the tiller 12a is lockable and locked by the tiller-latching mechanism.

As will be appreciated, by providing a lever element in the form of the tiller 12a, the outboard shaft 20a may be deployed and submerged carefully, in a controlled manner, by a person standing inside a watercraft, using the tiller 12a to slow the pivoting motion, rather than having to lean overboard and carry the weight of a motor in an awkward position, as was hitherto the case. Furthermore, by way of the connector-receiving portion 32a engaging in the connector bar 26a, in combination with a pivotable configuration of the connector-receiving portion 32a, the motor is already firmly attached to a transom before its main weight is pushed overboard. In practice, the arrangement reduces the risk of an outboard motor being dropped, because it allows a user to firmly grab the motor at convenient handle locations at different positions along the outboard shaft. Furthermore, should it still happen that the motor is dropped, which is a possibility that cannot be excluded entirely under unstable conditions at sea, then the motor is more likely to be dropped onboard, rather than while it is handled outboard.

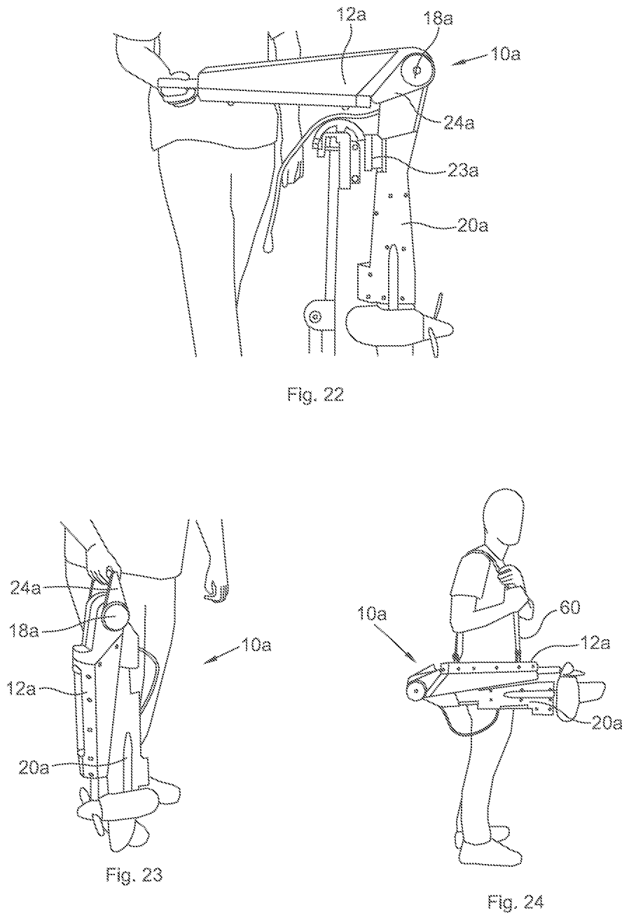

Moving from FIG. 20 to FIG. 21 and then FIG. 22, the tiller 12a may be released from the extended configuration by pivoting the handle lever 24a into its steering configuration. FIG. 20 shows the handle lever 24a in the tiller-latching position, preventing its pivoting towards the steering configuration. FIG. 21 shows the handle lever 24a in a tiller-releasing position, allowing the tiller 12a to be pushed downward, to be oriented at about 270 degrees relative to its stowed configuration along the outboard shaft 20a (FIG. 15). The tiller 12a is now deployed for use as a steering lever to control the lateral pivoting of the outboard shaft 20 about its steering axis, the steering axis conveniently being provided by the connector rod 26a engaged in the through hole of the connector-receiving portion 32a of the mounting bracket 40a.

To remove the outboard motor 10a from the watercraft, the sequence of steps is simply followed in reverse, although it will be appreciated that different embodiments of the invention may comprise different and/or additional clamps, latches and/or release mechanisms to further improve and/or facilitate the installation of the motor.

FIG. 23 illustrates the outboard motor 10a prototype in a stowed configuration, with the tiller 12a latched onto the outboard shaft 20a and the handle lever 24a in an extended configuration, in which it extends axially from an end of the outboard shaft 20a to provide a carry handle. In this configuration, most of the mass of the outboard motor 10a is located in a compact arrangement underneath the extended handle lever 24a, which allowed the outboard motor 10a to be carried single-handedly, in a vertical orientation.

FIG. 24 illustrates another possibility to carry the outboard motor 10a, by using a few or more of the above-mentioned carrier structures 16 (located within the body of the tiller 12a and not visible in FIG. 24) to attach a shoulder strap 60 or other appropriate carrier structure. As can be seen in FIG. 24, the outboard motor 10a can conveniently be carried by a single person using a shoulder strap. It will be appreciated that the latching force of the latch arrangement holding the tiller 12a to the outboard shaft 20a is of sufficient strength and/or reliability to avoid an unlatching of the tiller 12a unless purposefully released (e.g. by way of the handle lever 24a as shown in FIG. 11). It will be appreciated that the carrier structures may allow attachment of several straps or carrier structures to allow a motor to be carried by several people.

The single-person lift is believed to be practical for several motor sizes, possibly up to 25 kg, depending in part on jurisdictional health and safety requirements. A particular advantage is the compactness of the motor with the tiller folded alongside the outboard shaft and latched to the outboard shaft such that the weight of the motor can be carried using the tiller, or structures of the tiller, as a carry handle.

The outboard motor described herein is conveniently an electric motor type, however the invention is not so limited and may be used with other motors such as conventional combustion engine motors. The transom mount is, in the described embodiment, a sub-assembly intended to remain mounted on a watercraft. Providing the transom mount as a separate subassembly facilitates several aspects of motor installation. Firstly, the transom mount itself can be handled, aligned and maintained without having to also handle a motor attached to it. Secondly, the arrangement provides one option for a slidable engagement via the connector-receiving portion, which allows an outboard motor to be manually ‘slotted’ onto a transom structure without then having to tighten several bolts while balancing the motor, hanging overboard in a yet-unsecured manner. Third, by allowing a separate transom mount subassembly to remain on board, the mass of the overall motor to be carried is somewhat reduced.

The described embodiment comprises a connector-receiving portion as part of the transom bracket that is slidably receivable in a shaft of an outboard motor and slidable from a releasable position in which it can be pulled away from the shaft, to a retained position in which it cannot be pulled away from the shaft unless first slid back to the releasable position. As described above, in the releasable position the shaft is seated on a connector-receiving portion, providing a support against accidental dropping of the motor. As an alternative to the described arrangement, the slidable engagement may be provided by a shuttle structure located permanently on the outboard shaft for engagement with a connector-receiving portion on the transom bracket.

The described embodiment includes a pivotable connection for motor deployment as part of the transom bracket, the connector-receiving portion being pivotable relative to the transom-clamping portion. In embodiments, the connector-receiving portion may be fixed relative to the transom-clamping portion and the pivotable articulation may be provided by a mechanism mounted to the outboard motor shaft.

The described embodiments comprise a tiller pivot link at an end of the outboard shaft, however it will be understood that a pivot link may be located partway along the outboard shaft, for instance by way of lateral arms, in a manner that allows a tiller to be pivoted into an extended configuration to extend the shaft axis for better leverage.

By way of the above-described variations, it will be understood that the embodiment described with reference to the Figures is an example within the scope of the appended claims, and that various modifications may be made to the invention as defined by the claims.

1-21. (canceled)

22. An outboard propulsion unit mountable on a transom of a watercraft, the outboard propulsion unit comprising a tiller, an outboard shaft comprising a propulsion arrangement, and a transom mount for attachment to the transom, wherein the tiller is articulatable into an extended configuration axially aligned with the outboard shaft and extending from a tiller-connecting end of the outboard shaft.

23. The outboard propulsion unit according to claim 22, comprising a tiller-locking arrangement allowing the tiller to be locked in the extended configuration.

24. The outboard propulsion unit according to claim 22, wherein the tiller is articulatable into a steering configuration from the extended configuration.

25. The outboard propulsion unit according to claim 22, wherein the tiller is articulatable into a stowed configuration along the outboard shaft, and wherein the tiller is articulatable into a stowed configuration from the extended configuration.

26. The outboard propulsion unit according to claim 25, wherein the outboard shaft and the tiller comprise tiller-shaft-engaging structures configured to latch the tiller in the stowed configuration along the outboard shaft.

27. The outboard propulsion unit according to claim 22, wherein the tiller comprises a carrier handle arrangement located, when in a stowed configuration, opposite the outboard shaft.

28. The outboard propulsion unit according to claim 27, wherein at least a portion of the carrier handle arrangement is located near a shaft-connected end of the tiller.

29. The outboard propulsion unit according to claim 27, wherein at least a portion of the carrier handle arrangement is located near a propulsion end of the outboard shaft when the tiller is in the stowed configuration.

30. The outboard propulsion unit according to claim 22, wherein the tiller is articulatable by way of a pivotable connection.

31. The outboard propulsion unit according to claim 22, wherein the transom mount comprises a transom-mounting subassembly and a motor-receiving subassembly, the transom-mounting subassembly for attachment to the transom, the motor-receiving subassembly being connectable to the outboard shaft in a translatable engagement, the translatable engagement allowing positioning the motor-receiving subassembly at one of a plurality of shaft locations,
wherein at one of the shaft locations of the plurality of shaft locations the motor-receiving subassembly is detachable from the outboard shaft, and at another one of the shaft locations of the plurality of shaft locations the motor-receiving subassembly is retained on the outboard shaft.

32. An outboard propulsion unit mountable on a transom of a watercraft, the outboard propulsion unit comprising a tiller, an outboard shaft comprising a propulsion arrangement, and a transom mount for attachment to the transom,
wherein the transom mount comprises a transom-mounting subassembly and a motor-receiving subassembly, the transom-mounting subassembly for attachment to the transom, the motor-receiving subassembly being connectable to the outboard shaft in a translatable engagement, the translatable engagement allowing positioning the motor-receiving subassembly at one of a plurality of shaft locations,
wherein at one of the shaft locations of the a plurality of shaft locations the motor-receiving subassembly is detachable from the outboard shaft, and at another one of the shaft locations of the plurality of shaft locations the motor-receiving subassembly is retained on the outboard shaft.

33. The outboard propulsion unit according to claim 32, wherein the translatable engagement is a slidable engagement.

34. The outboard propulsion unit according to claim 32, wherein the outboard shaft comprises a track structure along which the motor-receiving subassembly is slidable, wherein the track structure comprises a rail section limiting rotation of the motor-receiving subassembly relative to the outboard shaft.

35. The outboard propulsion unit according to claim 34, wherein the track structure comprises a free section configured to permit rotation of the motor-receiving subassembly relative to the outboard shaft more than the rail section, the free section being at an end of the track structure.

36. The outboard propulsion unit according to claim 32, wherein the outboard shaft comprises a shuttle mechanism providing the translatable engagement, the shuttle mechanism configured to engage with a corresponding structure of the motor-receiving subassembly, the shuttle mechanism being translatable along a length of the outboard shaft.

37. The outboard propulsion unit according to claim 32, wherein the motor-receiving subassembly is pivotably connected on the transom-mounting subassembly.

38. The outboard propulsion unit according to claim 37, wherein the transom mount comprises a pivot-controlling interlock, the interlock mechanically preventing a pivoting of the motor-receiving subassembly and being releasable to permit pivoting of the motor-receiving subassembly.

39. The outboard propulsion unit according to claim 38, wherein the interlock is releasable by at least one of a release actuator located on the transom mount, and a release actuator located near a tiller-connecting end of the outboard shaft.

40. The outboard propulsion unit according to claim 32, wherein the outboard shaft comprises a rod structure engageable in a through hole of the motor-receiving subassembly.

41. The outboard propulsion unit according to claim 40, wherein the rod structure is exposed within a recess at a side of the outboard shaft so as to allow the motor-receiving subassembly to be slid onto it.
